(19) United States
(12) Patent Application Publication
(10) Pub. No.: US 2026/0185729 A1
(43) Pub. Date: Jul. 2, 2026

(54) AIR CONDITIONING DEVICE AND METHOD OF OPERATING THE SAME

(71) Applicant: SAMSUNG ELECTRONICS CO., LTD., Suwon-si (KR)

(72) Inventors: Hoyoung MAENG, Suwon-si (KR); Yunjae CHO, Suwon-si (KR); Doyoon KIM, Suwon-si (KR); Taegyu KIM, Suwon-si (KR)

(73) Assignee: SAMSUNG ELECTRONICS CO., LTD., Suwon-si (KR)

(21) Appl. No.: 19/448,923

(22) Filed: Jan. 14, 2026

Related U.S. Application Data
(63) Continuation of application No. PCT/KR2025/022868, filed on Dec. 26, 2025.

(30) Foreign Application Priority Data
Dec. 27, 2024 (KR) 10-2024-0198773

(51) Int. Cl. F24F 11/63; G05B 13/02

(52) U.S. Cl. CPC F24F 11/63; G05B 13/0265

(57) ABSTRACT

An air conditioning device including a sensing module including a first sensor processing an input signal of a first frequency band corresponding to first sensing data, the first sensing data includes a cough identification and a second sensor processing an input signal of a second frequency band corresponding to second sensing data, the second sensing data includes a dry cough identification; and at least one processor, wherein the processor is to: obtain the first sensing data through the first sensor; obtain, at a time period during which the first sensing data is obtained, the second sensing data through the second sensor; identify the first sensing data including the cough identification; extract amplitude information of at least a section of the second sensing data; and adjust air conditioning settings based on the amplitude information of the at least the section of the second sensing data including the dry cough identification.

### CROSS-REFERENCE TO RELATED APPLICATION(S)

This application is a U.S. National Stage application under 35 U.S.C. § 371 of an International application number PCT/KR 2025/022868, filed on Dec. 26, 2025, which is based on and claims priority of a Korean patent application number 10-2024-0198773, filed on Dec. 27, 2024, in the Ministry of Intellectual Property, the disclosure of each of which is incorporated by reference herein in its entirety.

### TECHNICAL FIELD

The embodiments disclosed in the disclosure relate to an air conditioning device and a method of operating the same.

### BACKGROUND ART

Recently, due to the development of smart home technology, customized environmental control technology utilizing artificial intelligence (AI) and internet of things (IoT) has been attracting attention. For example, a sensor included in an electronic device (e.g., an air conditioning device, a display device) included in a smart home may support user-centered control methods such as analyzing noise or detecting air quality. An air conditioning device may control an indoor space's temperature and humidity to provide a comfortable environment to a user, and temperature and humidity adjustment may be performed based on preset user input values. With the development of AI and IoT technology, technology for finely adjusting air conditioning conditions by adaptively reflecting a user's state is being developed.

### DISCLOSURE OF INVENTION

### Solution to Problems

In the case of temperature and humidity control of an air conditioning device, it may be performed based on a user's manual input values. However, when a user is in a state where it is difficult to manually control the air conditioning device (e.g., sleeping state), a circumstance may occur where the air conditioning device provides humidity and temperature that are not suitable for the user's physical condition. For example, when an indoor space where a sleeping user is positioned has a low temperature or is dry, it is necessary to identify this and adaptively adjust the air conditioning state.

Based on the discussion as described above, the disclosure relates to a device and method capable of adaptively adjusting air conditioning state considering a user's state.

An air conditioning device, according to an embodiment of the disclosure may include: a sensing module including a first sensor processing an input signal of a first frequency band corresponding to first sensing data, the first sensing data configured to include a cough identification and a second sensor processing an input signal of a second frequency band corresponding to second sensing data, the second sensing data configured to include a dry cough identification; and at least one processor electrically connected to the sensing module, wherein the at least one processor is configured to: obtain the first sensing data through the first sensor; obtain, at a time period during which the first sensing data is obtained, the second sensing data through the second sensor; identify the first sensing data including the cough identification; extract amplitude information of at least a section of the second sensing data; and adjust air conditioning settings of the air conditioning device based on the amplitude information of the at least the section of the second sensing data including the dry cough identification.

A method of operating an air conditioning device, the method may include: obtaining first sensing data of a first frequency band through a first sensor; obtaining, at a time period during which the first sensing data is obtained, second sensing data of a second frequency band through a second sensor; identifying the first sensing data includes a cough identification; extracting amplitude information of at least a section of the second sensing data; and adjusting air conditioning settings of the air conditioning device based on the amplitude information of the at least the section of the second sensing data including a dry cough identification.

An air conditioning device, according to an embodiment of the disclosure may include: a sensing module including a first sensor processing an input signal of a first frequency band corresponding to first sensing data, and a second sensor processing an input signal of a second frequency band corresponding to second sensing data; and at least one processor electrically connected to the sensing module, wherein the at least one processor is configured to: obtain the first sensing data through the first sensor; obtain, at a time period during which the first sensing data is obtained, the second sensing data through the second sensor, extract amplitude information of at least a section of the second sensing data; and adjust air conditioning settings of the air conditioning device based on the amplitude information of the at least the section of the second sensing data.

A method of operating an air conditioning device, the method may include: obtaining first sensing data of a first frequency band through a first sensor; obtaining, at a time period during which the first sensing data is obtained, second sensing data of a second frequency band through a second sensor; extracting amplitude information of at least a section of the second sensing data; and adjusting air conditioning settings of the air conditioning device based on the amplitude information of the at least the section of the second sensing data.

An air conditioning device according to an embodiment of the disclosure may include a sensing module including a first sensor processing an input signal of a first frequency band and a second sensor processing an input signal of a second frequency band, and at least one processor electrically connected to the sensing module. The at least one processor may be configured to extract amplitude information of at least a partial section of second sensing data in response to identifying first sensing data through the first sensor, and adjust air conditioning settings of the air conditioning device based on the amplitude information of the at least partial section of the second sensing data. The second sensing data may include data obtained through the second sensor during a time period in which the first sensing data was obtained.

According to an embodiment, the at least one processor may be configured to increase at least one of temperature or humidity of the air conditioning device in response to identifying that an average amplitude value of the at least partial section of the second sensing data is equal to or less than a predetermined value.

In an embodiment, the at least one processor may be configured to obtain information about at least one object included in an area where the second sensing data was sensed based on the second sensor. The information about the at least one object may include information about a position, shape, or movement of the at least one object.

In an embodiment, the at least one processor may be configured to adjust the airflow of the air conditioning device based on information about the position of the at least one object.

In an embodiment, the information about the at least one object may include data about a plurality of points obtained from the at least one object.

In an embodiment, the at least one processor may be configured to identify at least one user corresponding to the at least one object based on the data about the plurality of points.

In an embodiment, the air conditioning device may further include a memory and a communication unit electrically connected to the at least one processor. The at least one processor may be configured to obtain health information of at least one user from the memory or the communication unit, and adjust the air conditioning settings based on the health information of the at least one user.

In an embodiment, the air conditioning device includes a memory storing a first machine learning model trained to take sound data obtained through the first sensor as an input value and output whether the sound data corresponds to the first sensing data, the memory electrically connected to the at least one processor. The at least one processor may be configured to obtain sound data through the first sensor, divide the sound data into a plurality of time periods, extract a feature vector based on amplitude information of the plurality of time periods, and determine whether the sound data is first sensing data based on the feature vector and the first machine learning model. The first sensing data may include acoustic data classified as coughing.

In an embodiment, the first frequency band may have a value smaller than the second frequency band.

In an embodiment, the at least partial section of the second sensing data may include a partial section where an average change value of amplitude slope is maintained equal to or less than a predetermined value.

A method of operating an air conditioning device according to an embodiment of the disclosure may include extracting amplitude information of at least a partial section of second sensing data in response to identifying first sensing data of a first frequency band, and adjusting air conditioning settings of the air conditioning device based on the amplitude information of the at least partial section of the second sensing data. The second sensing data may include data of a second frequency band obtained during a time period in which the first sensing data was obtained.

In an embodiment, the method of operating the air conditioning device may include increasing at least one of temperature or humidity of the air conditioning device in response to identifying that an average amplitude value of the at least partial section of the second sensing data is equal to or less than a predetermined value.

In an embodiment, the method of operating the air conditioning device includes obtaining information about at least one object included in an area where the second sensing data was sensed. The information about the at least one object may include information about a position, shape, or movement of the at least one object.

In an embodiment, the method of operating the air conditioning device may include adjusting airflow of the air conditioning device based on information about the position of the at least one object.

In an embodiment, the information about the at least one object may include data about a plurality of points obtained from the at least one object.

In an embodiment, the method of operating the air conditioning device may include identifying at least one user corresponding to the at least one object based on the data about the plurality of points.

In an embodiment, the method of operating the air conditioning device may include obtaining health information of at least one user, and adjusting the air conditioning settings based on the health information of at least one user.

In an embodiment, the method of operating the air conditioning device includes obtaining sound data of the first frequency band, dividing the sound data into a plurality of time periods, extracting a feature vector based on amplitude information of the plurality of time periods, determining whether the sound data is first sensing data based on a first machine learning model trained to take the feature vector and the sound data of the first frequency band as input values and output whether the sound data corresponds to the first sensing data. The first sensing data may include acoustic data classified as coughing.

In an embodiment, the first frequency band may have a value smaller than the second frequency band.

In an embodiment, the at least partial section of the second sensing data may include a partial section where an average change value of amplitude slope is maintained equal to or less than a predetermined value.

The embodiments of the disclosure provide the effect of maintaining a user's health by adjusting the air conditioning state based on the user's physical condition.

Further, the embodiments of the disclosure provide the effect of promoting a user's sound sleep by optimally adjusting the air conditioning state around the user during sleep.

Effects of the disclosure are not limited to the foregoing, and other unmentioned effects would be apparent to one of ordinary skill in the art from the following description.

### BRIEF DESCRIPTION OF DRAWINGS

FIG. 1 illustrates a block configuration of an air conditioning device according to an embodiment of the disclosure.

FIG. 2 illustrates an example of sensing data of an air conditioning device according to an embodiment.

FIG. 3 illustrates an operation flow of an air conditioning device according to an embodiment.

FIG. 4 illustrates an operation flow of an air conditioning device according to an embodiment.

FIG. 5 illustrates an operation flow of an air conditioning device according to an embodiment.

FIG. 6 illustrates an operation flow of an air conditioning device according to an embodiment.

FIG. 7 illustrates an example of data processing of an air conditioning device according to an embodiment.

FIG. 8 illustrates an operation flow of an air conditioning device according to an embodiment.

In relation to the description of the drawings, identical or similar reference numerals may be used for identical or similar components.

### MODE FOR THE INVENTION

Hereinafter, the disclosure is described in detail with reference to the accompanying drawings. In the following description, specific details, such as detailed configurations and components, will be provided merely for a better understanding of embodiments of the disclosure. Accordingly, it should be apparent to one of ordinary skill in the art that various changes and modifications may be made to the embodiments described herein without departing from the scope and spirit of the disclosure. Further, no description is made of well-known functions and configurations for clarity and brevity.

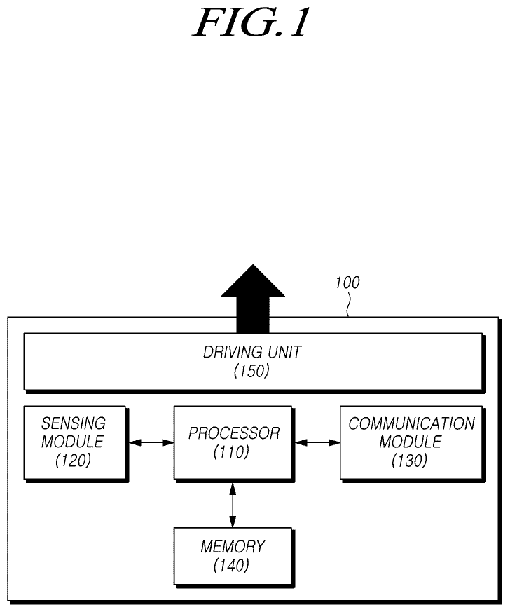

FIG. 1 illustrates a block configuration of an air conditioning device according to an embodiment.

Referring to FIG. 1, an air conditioning device 100 may include a communication module 130, a processor 110, a driving unit 150, a memory 140, and a sensing module 120.

In an embodiment, the processor 110 may control the overall operation of the air conditioning device 100.

In an embodiment, the processor 110 may control the air condition of a first area in response to a control signal (CS) transmitted from an electronic device. For example, the processor 110 may output air (e.g., cold air, warm air, and/or purified air) through the driving unit 150 in response to the control signal (CS). Further, in case that the air conditioning device 100 is a smart door, the processor 110 may open or close a door through the driving unit 150 in response to the control signal (CS).

In an embodiment, the driving unit 150 is a component for performing a function for circulation and temperature control of indoor air, and may generate wind and discharge it in a desired direction according to control of the processor 110.

In an embodiment, in case that the air conditioning device 100 is an air conditioner, the driving unit 150 may output cold air to a specific area.

In an embodiment, in case that the air conditioning device 100 is an air purifier, the driving unit 150 may output purified air to a specific area.

In an embodiment, in case that the air conditioning device 100 is a smart door, the driving unit 150 may open or close a door according to control of the processor 110.

In an embodiment, the memory 140 may store operation information (OI) and operation termination information (TI) of the air conditioning device 100. For example, the memory 140 may be implemented as a non-volatile memory.

In an embodiment, the memory 140 may store a first machine learning model trained to take sound data obtained through a microphone as an input value and output whether the sound data corresponds to acoustic data classified as coughing.

In an embodiment, the sensing module 120 may perform a function of detecting surrounding environment and user state of the air conditioning device 100 to optimize operation of the air conditioning device.

In an embodiment, the air conditioning device 100 may monitor temperature, humidity, sound, movement, etc. around the air conditioning device in real-time.

In an embodiment, the sensing module 120 may include a microphone, radar, an infrared sensor, a temperature and/or humidity sensor, etc.

In an embodiment, the sensing module 120 may automatically switch to a quiet mode by detecting a noise level through the microphone.

In an embodiment, the sensing module 120 may recognize a voice command through the microphone.

In an embodiment, the sensing module 120 may identify the user's coughing sound through the microphone.

In an embodiment, the sensing module 120 may detect the position or movement of a person present indoors through the radar.

In an embodiment, the sensing module 120 may determine whether coughing is dry coughing through the radar.

In an embodiment, the sensing module 120 may transmit detected information to the processor 110.

In an embodiment, the processor 110 may transmit the detected information transmitted from the sensing module 120 to another electronic device (e.g., a server device (not illustrated), the user device (not illustrated)).

In an embodiment, the communication module 130 may receive the control signal (CS) from the electronic device.

In an embodiment, the communication module 130 may transmit the control signal (CS) to the processor 110.

In an embodiment, the communication module 130 may transmit the operation information (OI) to the electronic device.

In an embodiment, the communication module 130 may also transmit the operation termination information (TI) to the electronic device.

In an embodiment, a display (not illustrated) may display an operation state of the air conditioning device 100.

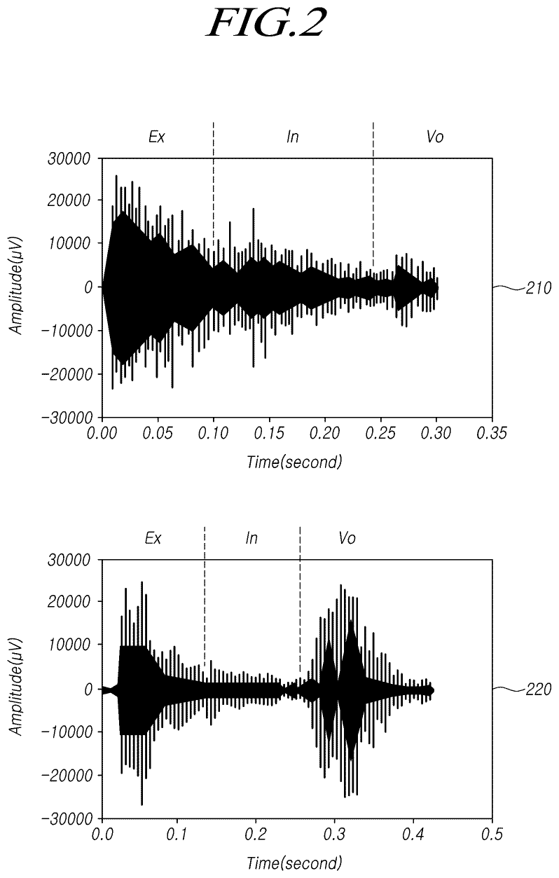

FIG. 2 illustrates an example of sensing data of an air conditioning device according to an embodiment. The air conditioning device of FIG. 2 may include a device corresponding to the air conditioning device 100 of FIG. 1.

According to an embodiment, the air conditioning device may obtain data through the sensing module (e.g., the sensing module 120) of the air conditioning device.

In an embodiment, the air conditioning device may obtain the user's coughing sound through a first sensor and a second sensor. The first sensor may include a sensor processing a signal of a first frequency band as an input. For example, the first sensor may include a microphone. A person's voice and various environmental noises may be identified through the first sensor. The second sensor may include a sensor processing a signal of a second frequency band as an input. For example, the second sensor may include a radar sensor (e.g., mmWave radar). Through the second sensor, a high-frequency signal may be emitted, and by analyzing a reflected signal, coughing sound identified from the user or physical responses such as the user's movement may be detected.

In an embodiment, the first frequency band may include an audible frequency band. For example, the first frequency band may correspond to 20 Hz to 20 kHz.

In an embodiment, the second frequency band may be higher than the first frequency band. For example, the second frequency band may include bands of 24 GHz, 60 GHz, 77-81 GHz.

In an embodiment, an acoustic signal identified through the first sensor may be converted to an electrical signal, and the air conditioning device or a server device may analyze the converted electrical signal (e.g., through a machine learning model) to determine whether the identified acoustic signal is a coughing sound. For example, the air conditioning device may analyze the electrical signal identified through the first sensor based on an algorithm detecting specific frequency patterns and sound pressure of coughing sounds.

In an embodiment, the second sensor may emit a signal of a higher frequency band than the first sensor, and may identify the user's coughing sound by monitoring a reflected signal. Sensing data obtained through the second sensor may have a higher resolution than sensing data sensed through the first sensor, and accordingly may identify not only whether the user's cough is simply coughing but also whether it is dry coughing. Coughing may be divided into productive coughing with phlegm and dry coughing without phlegm.

Referring to FIG. 2, first sensing data 210 and second sensing data 220 may represent an example of an acoustic signal identified through the first sensor or the second sensor.

In an embodiment, the first sensing data 210 and the second sensing data 220 may include acoustic data classified as coughing. The first sensing data 210 may include sensing data classified as productive coughing among coughs. The second sensing data 220 may include sensing data classified as dry coughing among coughs.

In an embodiment, the first sensing data 210 may be divided into a first phase (e.g., Explosive phase), a second phase (e.g., Intermediate phase), and a third phase (e.g., voiced phase). The first phase is the first stage occurring as air is rapidly released at the beginning of coughing, in which a strong and fast explosive sound may be identified. In the first phase, a very high amplitude peak may appear in a relatively short time, and may have a form in which amplitude rapidly rises and then quickly decreases. The amplitude value of the first phase may have a larger value than the other phases. The second phase may represent a stage in which remaining air is continuously discharged after explosive air release ends. An irregular sound may occur as air escapes through the throat. In the second phase, amplitude may change irregularly and have a gradually decreasing form. The beginning of the second phase may have a relatively high amplitude value, but the amplitude may gradually decrease over time. The third phase may represent the last stage of coughing. The third phase may represent sound occurring as vocal cords vibrate, and may include a stage in which voice is mixed in the latter portion of coughing.

In an embodiment, the average amplitude value of the second phase of the second sensing data 220 may have a smaller amplitude value than the average amplitude value of the second phase of the first sensing data 210.

In an embodiment, in case of determining that the user's coughing sound has been identified based on an acoustic signal obtained through the first sensor, the air conditioning device may identify second sensing data corresponding to a time period in which the corresponding acoustic signal was obtained. The second sensing data may include acoustic data obtained through the second sensor.

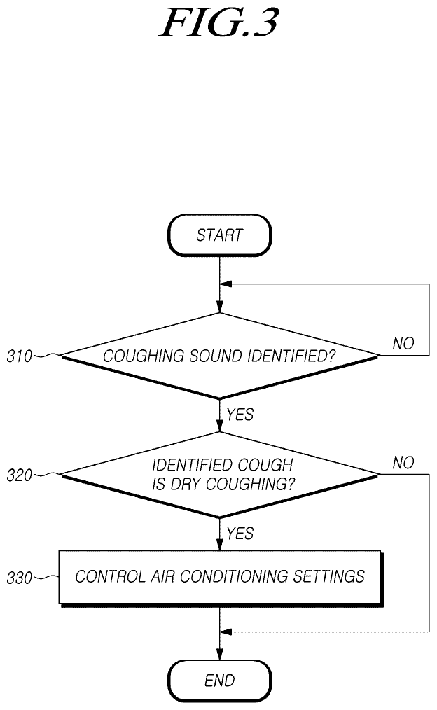

FIG. 3 illustrates an operation flow of an air conditioning device according to an embodiment. The air conditioning device of FIG. 3 may include a device corresponding to the air conditioning device of FIGS. 1 and 2.

According to an embodiment, in operation 310, the air conditioning device may determine whether a coughing sound is identified.

In an embodiment, the air conditioning device may monitor whether a coughing sound is identified.

In an embodiment, the air conditioning device may obtain an acoustic signal through a microphone. The air conditioning device may analyze the obtained acoustic signal and, in case that the analyzed acoustic signal is classified as a coughing sound, may determine that a coughing sound has been identified. For example, the air conditioning device may determine whether the obtained acoustic signal is a coughing sound using a machine learning model trained to predict whether it is a coughing sound by taking the acoustic signal as an input value. The operation flow of classifying an acoustic signal as a coughing sound may be described in detail in drawings to be described below.

In an embodiment, in case that a coughing sound is identified in operation 310, the air conditioning device may perform operation 320.

According to an embodiment, in operation 320, the air conditioning device may determine whether the identified coughing is dry coughing.

In an embodiment, the air conditioning device may determine whether the identified coughing sound is a dry coughing sound based on data obtained through a radar sensor.

In an embodiment, the air conditioning device may determine whether the coughing sound is a dry coughing sound by analyzing second sensing data, which is data identified through the radar sensor during a time period in which the acoustic signal identified as a coughing sound was identified through the microphone.

In an embodiment, the air conditioning device may divide the second sensing data into at least three time periods, and may determine whether the coughing sound is a dry coughing sound based on amplitude information of a middle time period among the three divided sections. For example, in case that the average amplitude value of the middle time period is smaller than a value predetermined according to the user, it may be determined that the coughing sound is a dry coughing sound. For example, by comparing the average amplitude value of the middle time period with the average amplitude value of the middle time period of another coughing sound recognized as productive coughing rather than dry coughing, it may be determined whether the identified coughing sound is dry coughing.

In an embodiment, the air conditioning device may determine whether second sensing data corresponding to first sensing data corresponds to a dry coughing sound based on a machine learning model trained to use data obtained through the second sensor as an input value and output whether the sound is dry coughing. In other words, based on a machine learning model trained to predict whether the user's coughing sound is dry coughing, it may be determined whether a coughing sound identified from the user is dry coughing.

In an embodiment, the air conditioning device may determine whether the coughing sound is dry coughing based on a change in amplitude per time period of the coughing sound and magnitude of amplitude values, etc.

According to an embodiment, in operation 330, the air conditioning device may control air conditioning settings.

In an embodiment, the air conditioning device may change temperature or humidity settings of the air conditioning device. For example, the air conditioning device may increase the set humidity. For example, the air conditioning device may activate a humidification function of an air conditioner to alleviate dry indoor air. For example, the air conditioning device may deactivate an activated dehumidification function. For example, the air conditioning device may activate an air purification function. For example, the air conditioning device may activate a ventilation mode. For example, the air conditioning device may adjust temperature to an appropriate temperature. For example, the air conditioning device may provide warm air by increasing the set temperature. For example, the air conditioning device may reduce cold air to prevent dryness.

In an embodiment, the air conditioning device may control the driving unit (e.g., the driving unit 150) so that airflow generated by the air conditioning device is directed to a specific area. For example, the air conditioning device may activate an indoor air circulation mode so that airflow may circulate better. For example, the air conditioning device may control the driving unit to change the direction of wind generated from the air conditioning device. For example, the air conditioning device may identify the user who had dry coughing and an area where the user is positioned, and may control the driving unit of the air conditioning device so that wind is directed to an area other than the corresponding user and the area where the corresponding user is positioned.

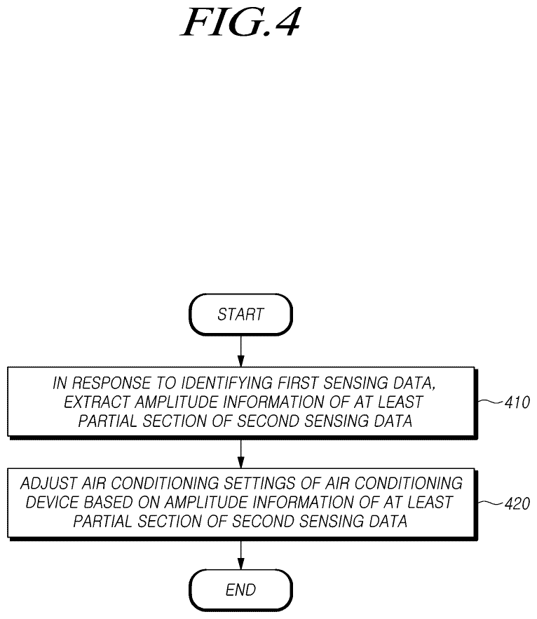

FIG. 4 illustrates an operation flow of an air conditioning device according to an embodiment. The operation flow of FIG. 4 may include all or some of the contents about operations described in the operation flow illustrated in FIG. 3. In the description of FIG. 4, descriptions of content overlapping with content described with reference to FIGS. 1 to 3 may be omitted.

According to an embodiment, in operation 410, the air conditioning device may extract amplitude information of at least a partial section of second sensing data in response to identifying first sensing data.

In an embodiment, the air conditioning device may include a first sensor (e.g., microphone) processing an input signal of a first frequency band and a second sensor (e.g., mmWave Radar) processing an input signal of a second frequency band. The first frequency band may include an audible frequency band. For example, the first frequency band may correspond to 20 Hz to 20 kHz. The second frequency band may be higher than the first frequency band. For example, the second frequency band may include bands of 24 GHz, 60 GHz, 77-81 GHz.

In an embodiment, the first sensing data may include acoustic data classified as a coughing sound among acoustic signals around the air conditioning device.

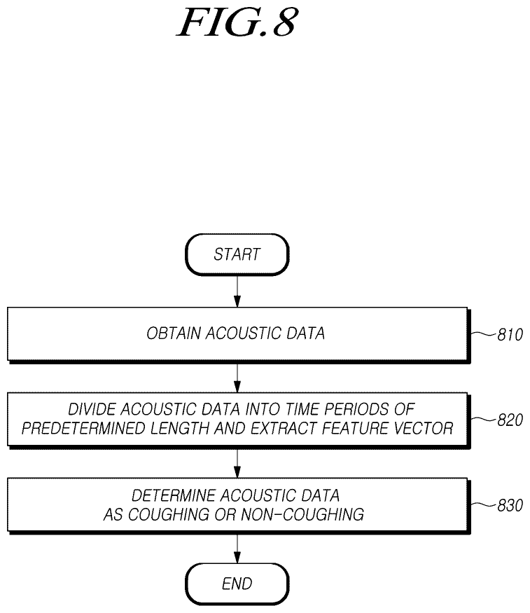

In an embodiment, in case that the air conditioning device identifies an acoustic signal through the first sensor, it may determine whether the corresponding acoustic signal corresponds to a coughing sound. The operation flow of the air conditioning device determining an acoustic signal as a coughing sound may be described in detail in the description regarding FIG. 8 to be described below.

In an embodiment, the second sensing data may include data obtained through the second sensor during a time period in which the first sensing data was obtained. In other words, the first sensing data may include data identified as a coughing sound among data obtained through the microphone, and the second sensing data may include data corresponding to that data, which is data obtained through the second sensor.

In an embodiment, the at least partial section of the second sensing data may include a second section (e.g., intermediate phase).

In an embodiment, the second section may be determined according to a predetermined period.

In an embodiment, the first section, the second section, and the third section may have the same length.

In an embodiment, the lengths of the first section, the second section, and the third section may be determined based on a change values of amplitude.

In an embodiment, the first section, the second section, and the third section may be determined based on an average value of the amplitudes.

According to an embodiment, in operation 420, the air conditioning device may adjust air conditioning settings of the air conditioning device based on amplitude information of at least a partial section of the second sensing data. The second sensing data may mean sensing data obtained through the second sensor during a time period in which acoustic data classified as an acoustic signal is identified through the first sensor (microphone).

In an embodiment, the air conditioning device may increase at least one of temperature or humidity of the air conditioning device in response to identifying that an average amplitude value of the at least partial section of the second sensing data is equal to or less than a predetermined value.

In an embodiment, the air conditioning device may obtain information about at least one object included in an area where the second sensing data was sensed based on the second sensor.

In an embodiment, the information about the at least one object may include information about a position, shape, or movement of the at least one object. For example, the information about the at least one object may include information about the user's position, the user's shape, the user's movement (e.g., movement of thorax), etc.

In an embodiment, the air conditioning device may adjust the airflow of the air conditioning device based on information about the position of the at least one object. For example, the air conditioning device may control the driving unit so that the airflow is not directed to the position of the user who had dry coughing, i.e., the area where the second sensing data was sensed.

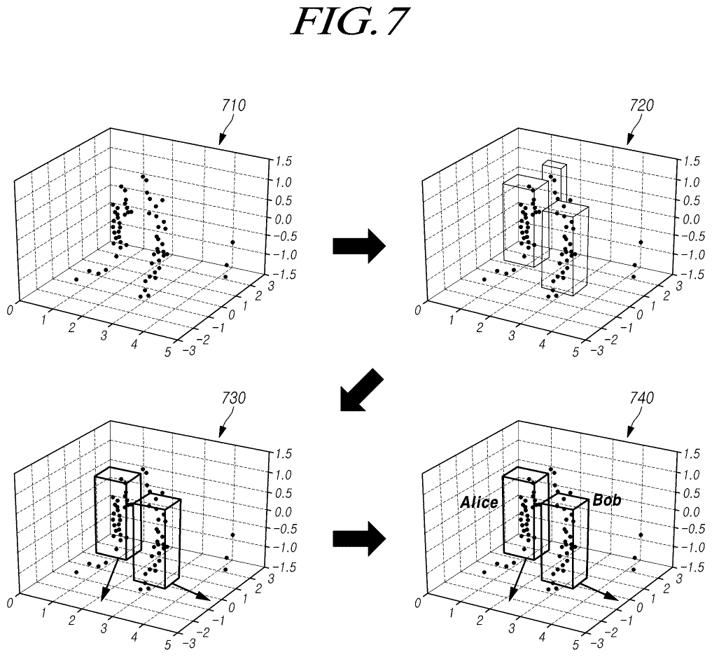

In an embodiment, the information about the at least one object may include data about a plurality of points obtained from the at least one object. FIG. 7 illustrates an example of data processing of an air conditioning device according to an embodiment. Referring to FIG. 7, the at least one piece of object information may include information about 3D point clouds illustrated in a first stage 710, a second stage 720, a third stage 730, and a fourth stage 740.

In an embodiment, the information about the at least one object may be generated based on time of flight (ToF), strength, etc of a signal reflected from an object (user) around the air conditioning device after being emitted through the second sensor. The at least one piece of object information may include a 3D point cloud. The at least one piece of object information may include 3D coordinate data of a space adjacent to the air conditioning device. For example, the at least one piece of object information may include spatial information such as distance, height, and size with respect to a specific object adjacent to the air conditioning device. The at least one piece of object information may be used for the air conditioning device to identify the shape and position of an object and detect the object's movement (e.g., coughing, dry coughing, simple movement) in real-time.

In an embodiment, the point cloud may include data about a plurality of points constituting a 3D space around the air conditioning device. The point cloud may include XYZ coordinate values of points constituting an object around the air conditioning device. The XYZ coordinate values may include spatial information where each point is positioned with respect to the air conditioning device. The point cloud may include reflection intensity values of points. The reflection intensity may indicate the intensity value of light reflected and returned at each point, and the characteristics of an object may be precisely analyzed based on the reflection intensity. For example, a metal surface may show high reflection intensity, while a surface with high absorption may show low reflection intensity.

In an embodiment, the air conditioning device may identify at least one user corresponding to the at least one object based on data about the plurality of points.

In an embodiment, the air conditioning device may obtain health information of the at least one user from the memory or the communication unit.

In an embodiment, the air conditioning device may adjust the air conditioning settings based on the health information of the at least one user.

In an embodiment, the air conditioning device may obtain sound data through the first sensor. The air conditioning device may divide the sound data into a plurality of time periods. The air conditioning device may extract a feature vector based on amplitude information of the plurality of time periods. The air conditioning device may determine whether the sound data is first type sound data based on the feature vector and a first machine learning model.

In an embodiment, the at least partial section of the second sensing data may include a partial section where an average change value of amplitude slope is maintained equal to or less than a predetermined value.

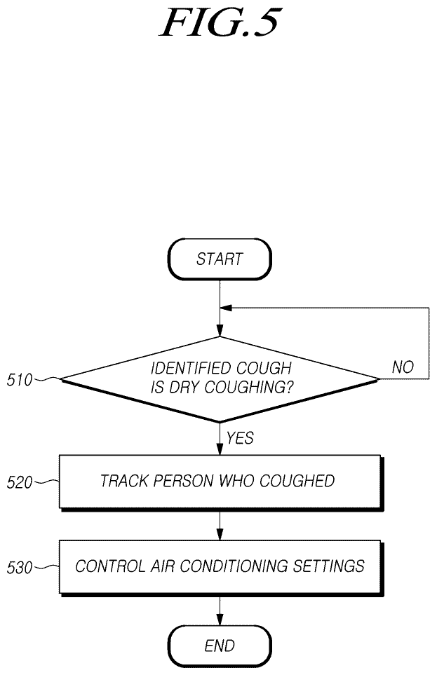

FIG. 5 illustrates an operation flow of an air conditioning device according to an embodiment. The air conditioning device of FIG. 5 may include all devices corresponding to the air conditioning device of FIGS. 1 to 4. In the description of FIG. 5, descriptions overlapping those described with reference to FIGS. 1 to 4 may be omitted. FIG. 5 may include all or some of the operation contents of FIGS. 3 and 4.

According to an embodiment, in operation 510, the air conditioning device may determine whether the identified coughing is dry coughing. Operation 510 may include all operation contents according to operations 320, 410, and 420.

In an embodiment, the air conditioning device may determine whether the identified coughing sound is a dry coughing sound based on data obtained through a radar sensor.

In an embodiment, the air conditioning device may determine whether the coughing sound is a dry coughing sound by analyzing second sensing data, which is data identified through the radar sensor during a time period in which the acoustic signal identified as a coughing sound was identified through the microphone.

In an embodiment, the air conditioning device may divide the second sensing data into at least three time periods, and may determine whether the coughing sound is a dry coughing sound based on amplitude information of a middle time period among the three divided sections. For example, in case that the average amplitude value of the middle time period is smaller than a value predetermined according to the user, it may be determined that the coughing sound is a dry coughing sound. For example, by comparing the average amplitude value of the middle time period with the average amplitude value of the middle time period of another coughing sound recognized as productive coughing rather than dry coughing, it may be determined whether the identified coughing sound is dry coughing.

In an embodiment, the air conditioning device may determine whether second sensing data corresponding to first sensing data corresponds to a dry coughing sound based on a machine learning model trained to use data obtained through the second sensor as an input value and output whether the sound is dry coughing. In other words, based on a machine learning model trained to predict whether the user's coughing sound is dry coughing, it may be determined whether a coughing sound identified from the user is dry coughing.

In an embodiment, the air conditioning device may determine whether the coughing sound is dry coughing based on a change in amplitude per time period of the coughing sound and magnitude of amplitude values, etc.

In an embodiment, the second sensing data may include data obtained through the second sensor during a time period in which the first sensing data was obtained. In other words, the first sensing data may include data identified as a coughing sound among data obtained through the microphone, and the second sensing data may include data corresponding to that data, which is data obtained through the second sensor.

In an embodiment, the at least partial section of the second sensing data may include a second section (e.g., intermediate phase).

In an embodiment, the second section may be determined according to a predetermined period.

In an embodiment, the first section, the second section, and the third section may have the same length.

In an embodiment, the lengths of the first section, the second section, and the third section may be determined based on a change values of amplitude.

In an embodiment, the first section, the second section, and the third section may be determined based on an average value of the amplitudes.

According to an embodiment, the second sensing data may mean sensing data obtained through the second sensor during a time period in which acoustic data classified as an acoustic signal is identified through the first sensor (microphone).

In an embodiment, the air conditioning device may determine that identified coughing is dry coughing in response to identifying that an average amplitude value of at least a partial section of the second sensing data is equal to or less than a predetermined value.

In an embodiment, the air conditioning device may detect vocal cord vibration occurring in the user's throat area in a non-contact manner using electromagnetic waves of a high frequency band (e.g., 30 GHz or higher) through the second sensor. The air conditioning device may determine identified coughing as general coughing in case that vocal cord vibration is clear, long, and repeatedly formed, and as dry coughing in case that vocal cord vibration is weak or occurs intermittently. The air conditioning device may analyze amplitude data and learn coughing patterns using machine learning models (RNN, LSTM), etc.

According to an embodiment, in case that the air conditioning device determines that coughing identified in operation 510 is dry coughing, the air conditioning device may perform operation 520.

According to an embodiment, in operation 520, the air conditioning device may track the person who coughed.

In an embodiment, the air conditioning device may identify a person who coughed based on second sensing data obtained through the second sensor. Information about objects existing adjacent to the air conditioning device may be obtained through the second sensor, and a person who coughed may be identified based on that information.

In an embodiment, the air conditioning device may sense shape and movement of an object adjacent to the air conditioning device, and may identify the user who had dry coughing based on the sensed shape and movement of the object. For example, in case that the shape of an object existing in an area where dry coughing occurred corresponds to a shape of a person lying down, and detecting that a partial area of the corresponding object (e.g., a person's thorax area) moves quickly, the air conditioning device may determine the corresponding object as the user who had dry coughing.

According to an embodiment, in operation 530, the air conditioning device may control air conditioning settings of the air conditioning device. For example, since identified coughing is dry coughing, the temperature of air being discharged may be raised or lowered to optimize humidity of space around the air conditioning device to alleviate dry coughing. For example, the air conditioning device may release a humidification mode or dehumidification mode. For example, the air conditioning device may control the direction of airflow so that airflow discharged by the air conditioning device is not directly directed to the user who coughed.

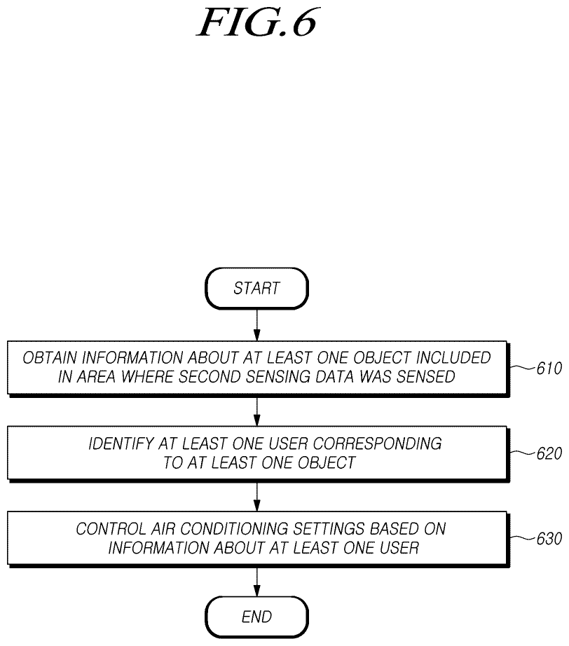

FIG. 6 illustrates an operation flow of an air conditioning device according to an embodiment. The air conditioning device of FIG. 6 may include all devices corresponding to the air conditioning device of FIGS. 1 to 5. In the description of FIG. 6, descriptions of content identical to content described with reference to FIGS. 1 to 5 may be omitted. The operation content of FIG. 6 may include all operation contents of FIGS. 3 to 5.

According to an embodiment, in operation 610, the air conditioning device may obtain information about at least one object included in an area where second sensing data was sensed.

In an embodiment, the air conditioning device may obtain information about at least one object included in an area where the second sensing data was sensed based on the second sensor.

In an embodiment, the information about the at least one object may include information about a position, shape, and movement of the at least one object. For example, the information about the at least one object may include information about the user's position, the user's shape, the user's movement (e.g., movement of thorax), etc.

In an embodiment, the air conditioning device may adjust the airflow of the air conditioning device based on information about the position of the at least one object. For example, the air conditioning device may control the driving unit so that the airflow is not directed to the position of the user who had dry coughing, i.e., the area where the second sensing data was sensed.

In an embodiment, the information about the at least one object may include data about a plurality of points obtained from the at least one object. FIG. 7 illustrates an example of data processing of an air conditioning device according to an embodiment. Referring to FIG. 7, the at least one piece of object information may include information about 3D point clouds illustrated in a first stage 710, a second stage 720, a third stage 730, and a fourth stage 740.

In an embodiment, the information about the at least one object may be generated based on time of flight (ToF), strength, etc of a signal reflected from an object (user) around the air conditioning device after being emitted through the second sensor. The at least one piece of object information may include a 3D point cloud. The at least one piece of object information may include 3D coordinate data of a space adjacent to the air conditioning device. For example, the at least one piece of object information may include spatial information such as distance, height, size with respect to a specific object adjacent to the air conditioning device. The at least one piece of object information may be used for the air conditioning device to identify the shape and position of an object and detect the object's movement (e.g., coughing, dry coughing, simple movement) in real-time.

In an embodiment, the point cloud may include data about a plurality of points constituting a 3D space around the air conditioning device. The point cloud may include XYZ coordinate values of points constituting an object around the air conditioning device. The XYZ coordinate values may include spatial information where each point is positioned with respect to the air conditioning device. The point cloud may include reflection intensity values of points. The reflection intensity may indicate the intensity value of light reflected and returned at each point, and the characteristics of an object may be precisely analyzed based on the reflection intensity. For example, a metal surface may show high reflection intensity, while a surface with high absorption may show low reflection intensity.

According to an embodiment, in operation 620, the air conditioning device may identify at least one user corresponding to at least one object.

In an embodiment, the air conditioning device may identify at least one user corresponding to the at least one object based on data about the plurality of points.

Referring to FIG. 7, in the first stage 710, the air conditioning device may obtain information about at least one object, i.e., data about a plurality of points. In the second stage 720, the air conditioning device may group the plurality of points to generate at least one candidate area. In the third stage 730, the air conditioning device may analyze points included in the at least one candidate area to identify a specific shape, and may determine an area determined to correspond to a person's shape as one user. In the fourth stage 740, the air conditioning device may identify a specific user (e.g., Alice, Bob) corresponding to the user's shape identified through points of the corresponding area.

According to an embodiment, in operation 630, the air conditioning device may control air conditioning settings based on information about at least one user. The information about the at least one user may include the user's identification information, state information (current body temperature, heart rate, fatigue level, etc.), health information (disease information held), the user's location information, etc.

In an embodiment, the air conditioning device may control the driving unit of the air conditioning device to provide temperature and humidity optimized for the user based on information about at least one user. For example, the air conditioning device may change temperature and humidity set to preferred temperature and humidity for each identified user. For example, in case that an identified user has a specific disease, the air conditioning device may control temperature and humidity so as not to worsen the corresponding disease. For example, the air conditioning device may control air conditioning settings of the air conditioning device so that the airflow is not formed to a location where the user who coughed is present.

FIG. 8 illustrates an operation flow of an air conditioning device according to an embodiment. The air conditioning device of FIG. 8 may include all devices corresponding to the air conditioning device of FIGS. 1 to 7. In the description of FIG. 8, descriptions of content overlapping with content described with reference to FIGS. 1 to 7 may be omitted. The operation content of FIG. 8 specifically describes the operation content for operation 310 of FIG. 3, and may include all operation contents for determining whether acoustic data identified through the first sensor (microphone) is first sensing data (data identified as coughing sound).

According to an embodiment, in operation 810, the air conditioning device may obtain acoustic data. The air conditioning device may obtain acoustic data generated in a space adjacent to the air conditioning device through the first sensor (microphone). In the following description, analyzing a signal obtained through the first sensor is taken as an example, but this is merely an example, and acoustic data may also be obtained through the second sensor (radar or lidar).

In an embodiment, the acoustic data may be collected at a sampling rate above a predetermined value. In obtaining the acoustic data, a noise removal filter may be used. The plurality of sensors may be used for obtaining the acoustic data.

According to an embodiment, in operation 820, the air conditioning device may divide the acoustic data into time periods of a predetermined length and extract a feature vector.

In an embodiment, the air conditioning device may process the acoustic data by dividing it into time periods of a predetermined length. For example, a window size may be 25 ms to 50 ms.

In an embodiment, the air conditioning device may extract a feature vector based on amplitude data per time period of the obtained acoustic data. The air conditioning device may perform pre-processing to normalize the extracted feature vector and input it to a learning model.

According to an embodiment, in operation 830, the air conditioning device may determine the acoustic data as coughing or non-coughing.

In an embodiment, the air conditioning device may determine the acoustic data as coughing or non-coughing using a machine learning model (on device AI) stored in the memory of the air conditioning device. The air conditioning device may determine the acoustic data as coughing or non-coughing using a model trained to determine whether it is coughing using acoustic data about coughing sounds and acoustic data about non-coughing sounds.

In an embodiment, in case that the acoustic data is determined to be a coughing sound, the air conditioning device may perform an operation to additionally determine whether the coughing sound is a dry coughing sound.

In an embodiment, in case that the air conditioning device determines that the identified coughing sound is a dry coughing sound, the air conditioning device may measure temperature and humidity of space adjacent to the air conditioning device, and may identify reference humidity based on information about the user who coughed. The air conditioning device may adjust humidity based on the identified reference humidity. The air conditioning device may define humidity adjustment time. The humidity adjustment time may be defined by adding the time taken to detect a coughing sound with the radar sensor, the time to analyze a signal and send a command to a humidity control device, physical operation delay time of the humidity control device, weighted time according to coughing factors (coughing sound volume, duration, frequency of occurrence), and time for how quickly the humidity control function reaches the set target humidity.

An air conditioning device according to an embodiment of the disclosure may include a sensing module including a first sensor processing an input signal of a first frequency band and a second sensor processing an input signal of a second frequency band, and at least one processor electrically connected to the sensing module. The at least one processor may be configured to extract amplitude information of at least a partial section of second sensing data in response to identifying first sensing data through the first sensor, and adjust air conditioning settings of the air conditioning device based on the amplitude information of the at least partial section of the second sensing data. The first sensing data may include acoustic data classified as coughing, and the second sensing data may include data obtained through the second sensor during a time period in which the first sensing data was obtained.

According to an embodiment, the at least one processor may be configured to increase at least one of temperature or humidity of the air conditioning device in response to identifying that an average amplitude value of the at least partial section of the second sensing data is equal to or less than a predetermined value.

In an embodiment, the at least one processor may be configured to obtain information about at least one object included in an area where the second sensing data was sensed based on the second sensor. The information about the at least one object may include information about a position, shape, or movement of the at least one object.

In an embodiment, the at least one processor may be configured to adjust the airflow of the air conditioning device based on information about the position of the at least one object.

In an embodiment, the information about the at least one object may include data about a plurality of points obtained from the at least one object.

In an embodiment, the at least one processor may be configured to identify at least one user corresponding to the at least one object based on the data about the plurality of points.

In an embodiment, the air conditioning device may further include a memory and a communication unit electrically connected to the at least one processor. The at least one processor may be configured to obtain health information of at least one user from the memory or the communication unit, and adjust the air conditioning settings based on the health information of the at least one user.

In an embodiment, the air conditioning device may include a memory storing a first machine learning model trained to take sound data obtained through the first sensor as an input value and output whether the sound data corresponds to acoustic data classified as coughing, the memory electrically connected to the at least one processor. The at least one processor may be configured to obtain sound data through the first sensor, divide the sound data into a plurality of time periods, extract a feature vector based on amplitude information of the plurality of time periods, and determine whether the sound data is first sensing data based on the feature vector and the first machine learning model.

In an embodiment, the first frequency band may have a value smaller than the second frequency band.

In an embodiment, the at least partial section of the second sensing data may include a partial section where an average change value of amplitude slope is maintained equal to or less than a predetermined value.

A method of operating an air conditioning device according to an embodiment of the disclosure may include extracting amplitude information of at least a partial section of second sensing data in response to identifying first sensing data of a first frequency band, and adjusting air conditioning settings of the air conditioning device based on the amplitude information of the at least partial section of the second sensing data. The first sensing data includes acoustic data classified as coughing, and the second sensing data may include data of a second frequency band obtained during a time period in which the first sensing data was obtained.

In an embodiment, the method of operating the air conditioning device may include increasing at least one of temperature or humidity of the air conditioning device in response to identifying that an average amplitude value of the at least partial section of the second sensing data is equal to or less than a predetermined value.

In an embodiment, the method of operating the air conditioning device includes obtaining information about at least one object included in an area where the second sensing data was sensed. The information about the at least one object may include information about a position, shape, or movement of the at least one object.

In an embodiment, the method of operating the air conditioning device may include adjusting airflow of the air conditioning device based on information about the position of the at least one object.

In an embodiment, the information about the at least one object may include data about a plurality of points obtained from the at least one object.

In an embodiment, the method of operating the air conditioning device may include identifying at least one user corresponding to the at least one object based on the data about the plurality of points.

In an embodiment, the method of operating the air conditioning device may include obtaining health information of at least one user, and adjusting the air conditioning settings based on the health information of at least one user.

In an embodiment, the method of operating the air conditioning device may include obtaining sound data of the first frequency band, dividing the sound data into a plurality of time periods, extracting a feature vector based on amplitude information of the plurality of time periods, determining whether the sound data is first sensing data based on a first machine learning model trained to take the feature vector and the sound data of the first frequency band as input values and output whether the sound data corresponds to acoustic data classified as coughing.

In an embodiment, the first frequency band may have a value smaller than the second frequency band.

In an embodiment, the at least partial section of the second sensing data may include a partial section where an average change value of amplitude slope is maintained equal to or less than a predetermined value.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor 110) of the machine (e.g., the an air conditioning device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An air conditioning device, comprising:
a sensing module including a first sensor processing an input signal of a first frequency band corresponding to first sensing data, and a second sensor processing an input signal of a second frequency band corresponding to second sensing data; and
at least one processor electrically connected to the sensing module, wherein the at least one processor is configured to:
obtain the first sensing data through the first sensor;
obtain, at a time period during which the first sensing data is obtained, the second sensing data through the second sensor;
extract amplitude information of at least a section of the second sensing data; and
adjust air conditioning settings of the air conditioning device based on the amplitude information of the at least the section of the second sensing data.

2. The air conditioning device of claim 1, wherein the at least one processor is configured to: increase at least one of temperature of the air conditioning device or humidity of the air conditioning device in response to identifying that an average amplitude value of the at least the section of the second sensing data is equal to or less than a predetermined value.

3. The air conditioning device of claim 2, wherein the at least one processor is configured to: obtain information about at least one object included in an area where the second sensing data was sensed based on the second sensor, and
wherein the information about the at least one object includes information about a position, shape, or movement of the at least one object.

4. The air conditioning device of claim 3, wherein the at least one processor is configured to: adjust airflow of the air conditioning device based on the information about the position of the at least one object.

5. The air conditioning device of claim 3, wherein the information about the at least one object includes data about a plurality of points obtained from the at least one object.

6. The air conditioning device of claim 5, wherein the at least one processor is configured to identify at least one user corresponding to the at least one object based on the data about the plurality of points.

7. The air conditioning device of claim 4, further comprising a memory and a communication unit electrically connected to the at least one processor, wherein the at least one processor is configured to:
obtain health information of at least one user from the memory or the communication unit; and
adjust the air conditioning settings based on the health information of the at least one user.

8. The air conditioning device of claim 1, comprising a memory storing a first machine learning model trained to take sound data obtained through the first sensor as an input value and output whether the sound data corresponds to the first sensing data, the memory electrically connected to the at least one processor, wherein the at least one processor is configured to:
obtain sound data through the first sensor;
divide the sound data into a plurality of time periods;
extract a feature vector based on amplitude information of the plurality of time periods; and
determine whether the sound data is the first sensing data based on the feature vector and the first machine learning model, the first sensing data including acoustic data classified as coughing.

9. The air conditioning device of claim 1, wherein the first frequency band is smaller than the second frequency band.

10. The air conditioning device of claim 1, wherein the at least the section of the second sensing data includes a section where an average change value of amplitude slope is maintained as equal to or less than a predetermined value.

11. A method of operating an air conditioning device, the method comprising:
obtaining first sensing data of a first frequency band through a first sensor;
obtaining, at a time period during which the first sensing data is obtained, second sensing data of a second frequency band through a second sensor;
extracting amplitude information of at least a section of the second sensing data; and
adjusting air conditioning settings of the air conditioning device based on the amplitude information of the at least the section of the second sensing data.

12. The method of claim 11, comprising increasing at least one of temperature of the air conditioning device or humidity of the air conditioning device in response to identifying that an average amplitude value of the at least the section of the second sensing data is equal to or less than a predetermined value.

13. The method of claim 12, comprising obtaining information about at least one object included in an area where the second sensing data was sensed,
wherein the information about the at least one object includes information about a position, shape, or movement of the at least one object.

14. The method of claim 13, comprising adjusting airflow of the air conditioning device based on the information about the position of the at least one object.

15. The method of claim 13, wherein the information about the at least one object includes data about a plurality of points obtained from the at least one object.

16. The method of claim 15, comprising identifying at least one user corresponding to the at least one object based on the data about the plurality of points.

17. The method of claim 14, comprising:
obtaining health information of at least one user; and
adjusting the air conditioning settings based on the health information of the at least one user.

18. The method of claim 11, comprising:
obtaining sound data of the first frequency band;
dividing the sound data into a plurality of time periods;
extracting a feature vector based on amplitude information of the plurality of time periods; and
determining whether the sound data is the first sensing data based on a first machine learning model trained to take the feature vector and the sound data of the first frequency band as input values and output whether the sound data corresponds to the first sensing data,
the first sensing data including acoustic data classified as coughing.

19. The method of claim 11, wherein the first frequency band is smaller than the second frequency band.

20. The method of claim 11, wherein the at least the section of the second sensing data includes a section where an average change value of amplitude slope is maintained as equal to or less than a predetermined value.
